(19) United States
(12) Patent Application Publication
(10) Pub. No.: US 2018/0167021 A1
(43) Pub. Date: Jun. 14, 2018

(54) Structure and Support Member for Installation of Photovoltaic Arrays on Roofs with Tile

(71) Applicant: Everest Solar Systems, LLC, Oceanside, CA (US)

(72) Inventor: Justin Eugene O'Rourke, Moreno Valley, CA (US)

(21) Appl. No.: 15/834,570

(22) Filed: Dec. 7, 2017

Related U.S. Application Data
(60) Provisional application No. 62/431,022, filed on Dec. 7, 2016.

(51) Int. Cl. H02S 20/23; H02S 30/10

(52) U.S. Cl. CPC H02S 20/23; H02S 30/10

(57) ABSTRACT

A PV array rail mounting system for use on support structures that include a substrate and covering material. In an aspect, the PV array rail mounting system is configured to be mounted to a roof with various tile types. In an aspect, the PV array rail mounting system includes a mounting hook for shared rails that allow the rails to be adjustably mounted. The overall PV array rail mounting system is configured to allow a rail be mounted on a roof tiles without the excessive removal of such tiles when mounted.

### CROSS-REFERENCE TO RELATED APPLICATIONS

The present application claims priority from Provisional Patent Application No. 62/431,022, filed on Dec. 7, 2016, the disclosure of which is relied upon and incorporated herein by reference.

### FIELD OF INVENTION

This invention generally relates to photovoltaic arrays, and more particularly to a structure and support member for photovoltaic (PV) arrays and associated hardware.

### BACKGROUND OF THE INVENTION

A photovoltaic (PV) installation typically includes a collection of photovoltaic modules combined and placed in a support structure that combines each of the photovoltaic components to form a photovoltaic array. Typically, photovoltaic arrays are placed in an outdoor location, commonly rooftops, so that the photovoltaic arrays are exposed to sunlight in order to produce electricity.

The most common types of sloped roofs are typically covered with composition shingles and tiles of various shapes, including, but not limited to, flat, S, W, etc. The difficulty of installing any solar system on a tile roof is that unlike composition shingles, the tiles themselves are somewhat delicate. Further, unlike composition shingles, tiles cannot be used as structural members to support the loads a photovoltaic system imparts on the roof due to gravity loads, wind loads, snow loads and others. One solution to this dilemma has been the adoption of so-called “tile hooks” that are mounted to the substructure of the roof, and then wrap around the existing tile, such that the loads mentioned above do not affect the tile.

Additionally, there are two common mounting solutions for PV modules on a sloped roof: a dual rail system (see FIG. 1), and a shared rail system. (see FIG. 2) Dual rail systems have two rails under each east/west row of solar modules. Shared rail systems have rails between east/west module rows, and at the northern-most and southern-most edges of the array. The main advantage of a shared rail system over dual rail systems is reduced component count, fewer attachment points, and hence, lower labor and part cost. However, shared rail systems also have disadvantages: shared rail systems requires a high degree of precision in locating the rails in the North/South direction, and increased loads on each roof mounting location because they are fewer mounting locations to distribute the load.

For shared rail systems used on composition shingle installations, the precision disadvantage has been overcome by utilizing slider mechanisms that incorporate north/south adjustability. However, given the light weight nature of tile hooks, and the increased loads due to shared rail configuration, such slider mechanisms haven't been implemented.

Therefore, there is a need for a shared rail system and method for installation of module mounting rails on tiled surfaces that addresses the shortcomings discussed above.

### SUMMARY OF THE INVENTION

Photovoltaic (PV) arrays routinely require hardware to support construction and installation. Embodiments of the present invention provide a PV array rail mounting system. In an aspect, the PV array rail mounting system is configured to be used on support structures that include a substrate such as, but not limited, to plywood, rafters, and battens and a covering material.

In an aspect, the PV array rail mounting system includes shared rails. The shared rails can be configured to allow PV panels to share rail sections, as shown in FIG. 2. The shared rail system reduces roof attachments and installation time compared to a dual rail system.

In an exemplary aspect, the PV array rail mounting system is configured to be mounted to a roof with various tile types, including, but not limited to, Flat, S and W tiles, which can comprise, but are not limited to, concrete and clay. In other aspects, the roof structures can include any type of timber or metal framed building with structural rafters.

In an aspect, the PV array rail mounting system includes a mounting hook for shared rails. The mounting hook is configured to be mounted on a roof and to hold the shared rails. The mounting hook is further configured to allow the rails to be adjustably mounted. In an aspect, the mounting hook includes a means to allow the shared rails to be slidably adjusted. In an aspect, the mounting hook is configured to be mounted on the roof with a base plate. The rail is configured to receive mounting systems for PV array components. The overall PV array rail mounting system is configured to allow a rail be mounted on a roof tiles without the excessive removal of such tiles when mounted.

These and other objects and advantages of the invention will become apparent from the following detailed description of the preferred embodiment of the invention. Both the foregoing general description and the following detailed description are exemplary and explanatory only and are intended to provide further explanation of the invention as claimed.

The accompanying drawings are included to provide a further understanding of the invention and are incorporated in and constitute part of this specification, illustrate several embodiments of the invention that together with the description serve to explain the principles of the invention.

### BRIEF DESCRIPTION OF THE FIGURES

FIG. 1 is a perspective view of a photovoltaic (PV) array using a dual rail mounting system known in the prior art.

FIG. 2 is perspective view of the PV array using a PV array rail mounting system mounted on a roof according to aspects of the present invention.

FIG. 3 is perspective view of components of the PV array rail mounting system of FIG. 2.

FIG. 4 is a cross-sectional view of the PV array rail mounting system of FIG. 2 mounted on a roof according to an aspect of the present invention.

FIG. 5 is a perspective elevated view of a mounting hook of the PV array rail mounting system of FIG. 4 according to an aspect of the present invention.

FIG. 6 is a side plan view of the mounting hook of FIG. 5 according to an aspect of the present invention.

FIG. 7 is a front plan view of the mounting hook of FIG. 5 according to an aspect of the present invention.

FIGS. 8 and 8A-C illustrates a side plan view of the mounting hook of FIG. 5 according to an aspect of the present invention.

FIGS. 9 and 9E-I illustrates a side plan view of the mounting hook of FIG. 5 according to an aspect of the present invention.

FIG. 10 illustrates a perspective elevated view of a base plate according to an aspect of the present invention.

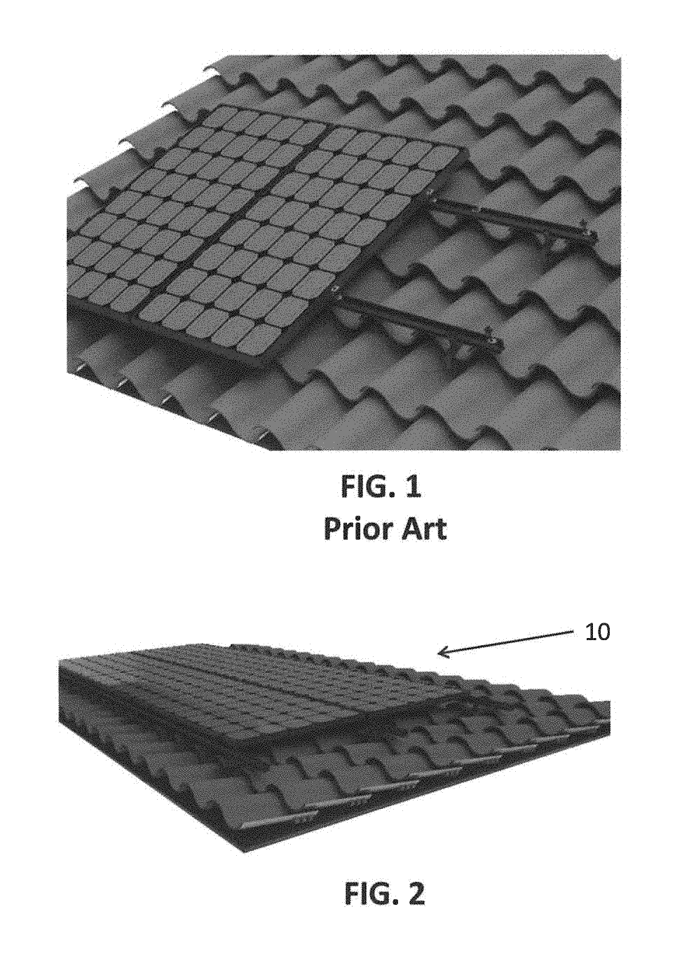

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the following description, numerous specific details are set forth. However, it is to be understood that embodiments of the invention may be practiced without these specific details. In other instances, well-known methods, structures and techniques have been shown in detail in order not to obscure an understanding of this description.

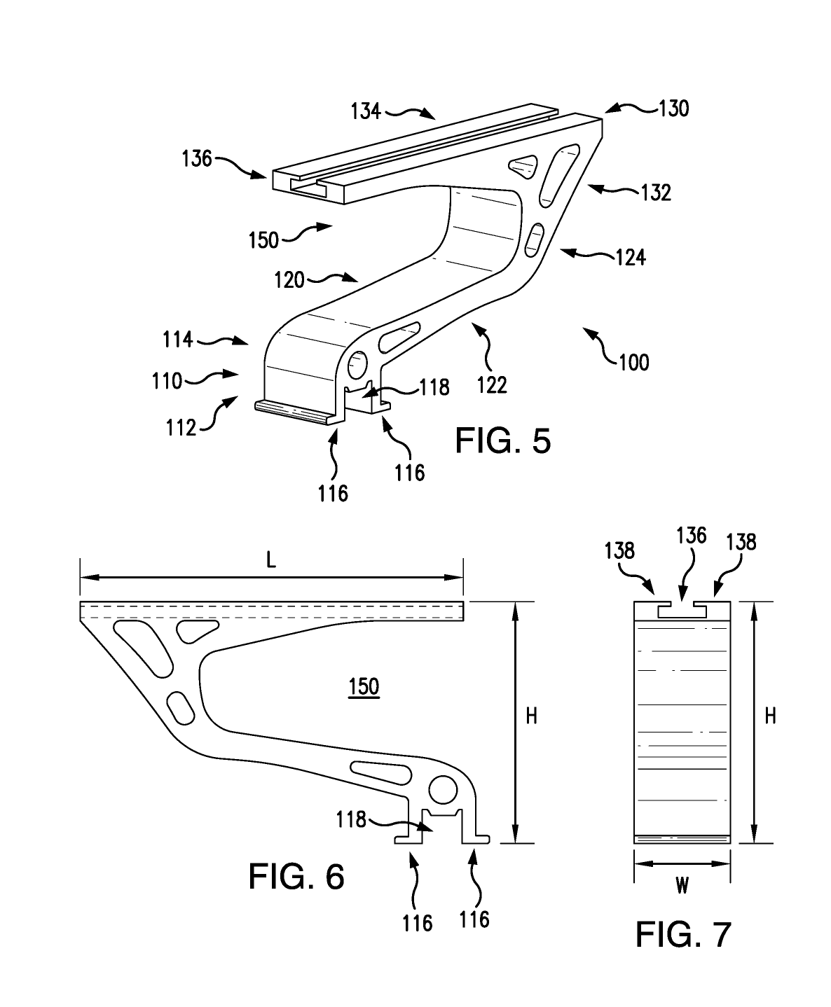

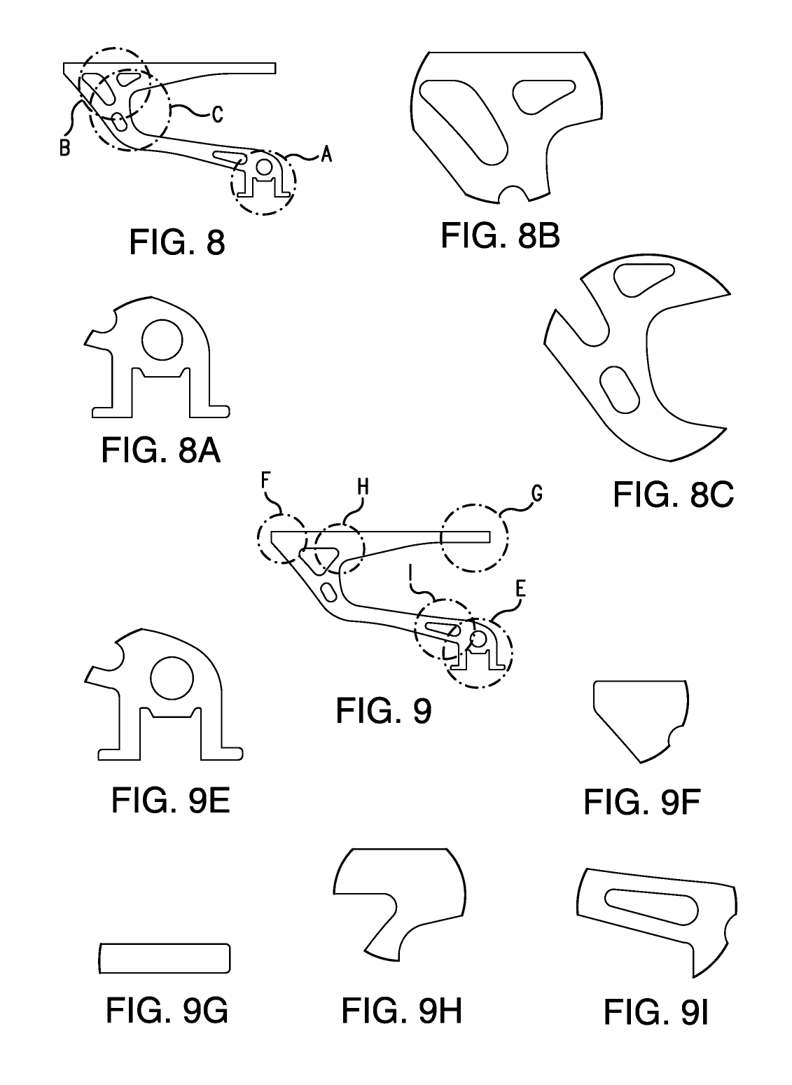

The present invention, as shown in FIGS. 2-10, is directed towards a photovoltaic (PV) array rail mounting system (PARM) 10. In an aspect, as illustrated in FIGS. 2-4, the PARM system 10 includes a mounting hook 100, a base plate 200, a rail mounting bracket 300, and a rail 400. The PARM system 10 is configured to provide support to solar components 500, including, but not limited to, PV panels, racking components, wind deflectors, ballast pans, micro-inventers, optimizers, wire management solutions, and the like commonly used in solar panel mounting systems.

In an aspect, the PARM system 10 is configured to be used on support structures that include a substrate 20 including, but not limited to, plywood, rafters, and battens and a covering material. The PARM 10 can be mounted on surfaces 20 that traditionally have tile 30 and other similar coverings that require some modification for solar mounting systems. In an exemplary aspect, the PARM system 10 is configured to be mounted on roofs 20 and other structures covered in tile 30. Such tile 30 can include, but is not limited to, flat, S, and W shaped tiles 30. The composition of such tiles 30 can include, but is not limited to, concrete and clay. While the PARM system 10 is configured for mounting on roofs/surfaces 20 covered with tile 30, the PARM system 10 can be used in other roof structures, or any other structure that include any type of timber or metal framed building with structural rafters.

In an aspect, the PARM system 10 can include multiple mounting hooks 100, base plates 200, and rail mounting brackets 300 with a single shared rail 400. The PARM system 10 can also include several shared rails 400, each rail 400 with multiple other components (mounting hooks 100, base plates 200, and rail mounting brackets 300).

The PARM system 10 is configured to allow solar components 500 (e.g., PV panels) to be mounted on roofs 20 covered by tiles 30, with the mounting hook 100 shaped to fit around the tiles, as shown in FIGS. 4-9. In an aspect, the mounting hook 100 includes a height (H), a length (L), and a width (W), as shown in FIGS. 6-7. In an aspect, the height and the length of the mounting hook 100 are greater than the width of the mounting hook 100.

In an aspect, the mounting hook 100 can be formed from materials that can withstand exposure to environmental elements while meeting the standards of the solar panel industry. Such standards include, but are not limited to, UL 2703 and UL 1703. For example, the mounting hook 100 can be made from, but not limited to, metallic materials (e.g, aluminum, stainless steel, and the like), polymer materials (e.g., plastics and the like), and other materials. In an exemplary aspect, the mounting hook 100 is made from aluminums including, but not limited to, AL 6061-T6, 6063-T66, 6005A-T5, 6006A-T61, or the equivalent.

The mounting hook 100 comprises a roof mount member 110, a support member 120, and a rail mount member 130. The roof mount member 110 is found along a bottom portion of the mounting hook 100, and is configured to be mounted to the roof 20 or other support structure on which the solar components 500 are to be arranged. The roof mount member 110 includes a bottom portion 112 and a top portion 114. In an aspect, the roof mount member 110, and more specifically the bottom portion 112, is further configured to engage with the base plate 200. In an exemplary aspect, the bottom portion 112 of the roof mount member 110 of the mounting hook 100 can include flanges 116, with the flanges 116 oriented along sides of the bottom portion 112 of the roof mount member 110. In an aspect, the flange 116 can extend from opposite sides of the bottom portion 112. In an exemplary aspect, the flanges 116 extend in same direction of the length L of the mounting hook 100. The bottom portion 112 can also include a notched section 118, discussed in more detail below.

The top portion 114 of the roof mount member 110 extends into a support member 120. The support member 120 includes a substantially horizontal portion 122 that extends into an angled vertical portion 124. The angled vertical portion 124 then connects into a rail mount member 130 of the mounting hook 100. In an aspect, the angled vertical portion 124 supports the rail mount member 130 and intersects the rail mount member 130 along a bottom portion 132 of the rail mount member 130. In an exemplary aspect, the angled vertical portion 124 grows in size as it travels from the substantially horizontal portion 122 upwards into the rail mount member 130 in order to provide more support for the rail mount bracket 300, rail 400, and solar components 500 when mounted.

The rail mount member 130 further includes a top surface 134 that is configured to support the rail mounting bracket 300 and rail 400. In an aspect, the top surface 134 includes a channel 136 that extends along the length 104 of rail mount member 130 and through the ends of the rail mount member 130. The top of the channel 136 includes extended flanges 138, narrowing the entry of the channel 136 at the top, but allowing the insertion of a retaining device for the rail mounting bracket 300 at the ends of the channel 136. The configuration of the channel 136 and the flanges 138 provides for the slidable adjustment of the rail mounting bracket 300 and rail 400, discussed in more detail below.

In an aspect, the roof mount member 110, the angled support member 120, and the rail mount member 130 together form a tile opening 150 in the mounting hook 100. The tile opening 150 allows for the mounting hook 100 to be mounted to a roof 20 with tile with minimal removal of tile 30 during installation. By providing the opening 150, only one tile 30 per mounting hook 100 needs to be temporarily removed and later replaced. This is a vast improvement over other known solar mounting systems which require several tiles 30 to be removed, some permanently or temporarily, with the addition of adding cover to the roof substrate.

In an aspect, the roof mount member 110, the angled support member 120, and the rail mount member 130 can be made from a single piece of material. In other aspects, the members 110, 120, and 130 can be formed from individual components and then connected through various connecting means. Regardless of whether the members 110, 120, and 130 are made from a single piece of material or multiple components, the mounting hook 100 needs to be strong enough to provide support of the other components of the PARM system 10 without breaking.

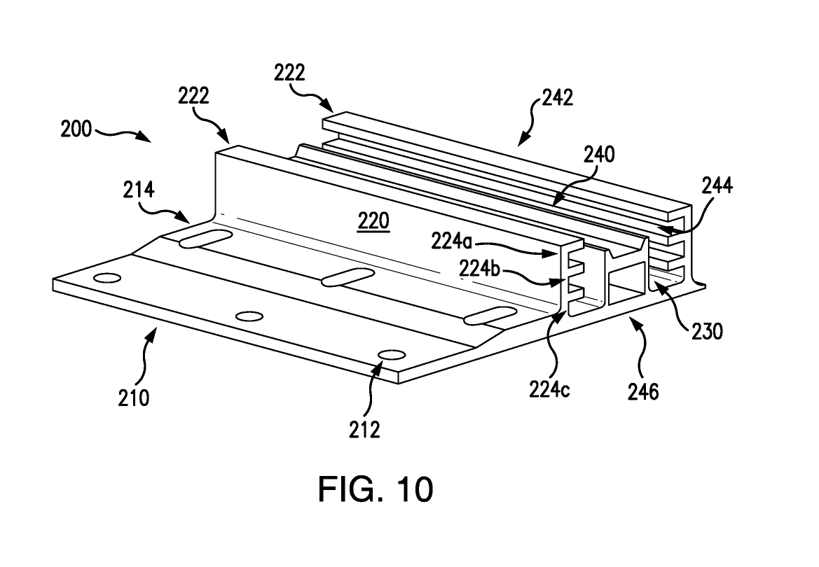

In an aspect, the mounting hook 100 is configured to be mounted onto the base plate 200 (see FIGS. 4 and 10). The base plate 200 is configured to be secured to the roof/support surface. In an aspect, the base plate 200 is configured to be mounted onto the support base of a roof structure underneath the tiles, as shown in FIG. 4. In an aspect, the base plate 200 includes a base member 210 and an engaging member 220 that extends upward from the surface of the base member 210. In an aspect, the base member 210 can include multiple apertures 212, 214 that are configured to receive fastening devices 218 to secure the base plate 200 to the roof sub-surface 20. In an aspect, the engaging member 220 is oriented on a side of the base member opposite of the apertures 212, 214, allowing the mounting hook 100 to be located as close to the front tile 30 as possible (see FIG. 4). The mounting hook 100 needs to be installed on the lowest side of the tile 30 in order for the angled support member 120 and the rail mount member 130 to extend over the tile 30. In an aspect, the apertures 212, 214 can include substantially rounded apertures 212 and elongated apertures 214 to insure that no confusion occurs in the alignment of the base plate 200 when installed.

The engaging member 220 is configured to engage with the mounting hook 100. More specifically, the engaging member 220 is configured to engage with the roof mount member 110 of the mounting hook 100. The engaging member 220 includes two vertical walls 222 that surround a tab 230 and form a channel 240. In an aspect, the channel 240 is accessible from a top opening 242 and side openings 244 (only one shown), with the base member 210 forming the floor 246 of the channel 240, as well as supporting the tab 230. In an aspect, the two vertical walls 222 include horizontal flanges 224 extending from interior sides of the vertical walls 222. The horizontal flanges 224 extend partially into the channel 240, leaving space between the flanges 224 and the tab 230. In an aspect, each vertical wall 222 includes multiple flanges 224. In an exemplary aspect, there are three flanges 224a, 224b, 224c for each wall 222. However, in other embodiments, various numbers of flanges 224 can be employed.

The combination of the horizontal flanges 224a, 224b, 224c and the tab 230 are configured to retain the roof mount member 110 of the mounting hook 100. In an aspect, the bottom portion 112 of the roof mount member 110 of the mounting hook 100 is received within the channel 240 of the engaging member 220. In such aspects, the bottom portion 112 of the roof mount member 110 is inserted into one of the side openings 244 of the channel 240, with the notched portion 118 of the roof mount member 100 receiving the tab 230 of the base plate 200. In an aspect, the profile of the tab 230 can substantially match the profile of the notched portion 118 of the mounting hook 100 in order to provide a more secure fit.

In an aspect, the three sets of flanges 224a, 224b, 224c within the channel 240 provide a means to adjust the height of the mounting hook 100 within the mounting member 220 of the base plate 200. By providing three sets of flanges 224a, 224b, 224c, the mounting member 220 provides three different height positions for the mounting hook 100, with the flanges 116 of the rail mount member 110 being retained between a combination of adjacent flanges 224a, 224b, 224c, and the floor 246 of the base plate 200. In addition, the tab 230 further engages the notched portion 118 to assist in securing the mounting hook 100 to the base plate 200.

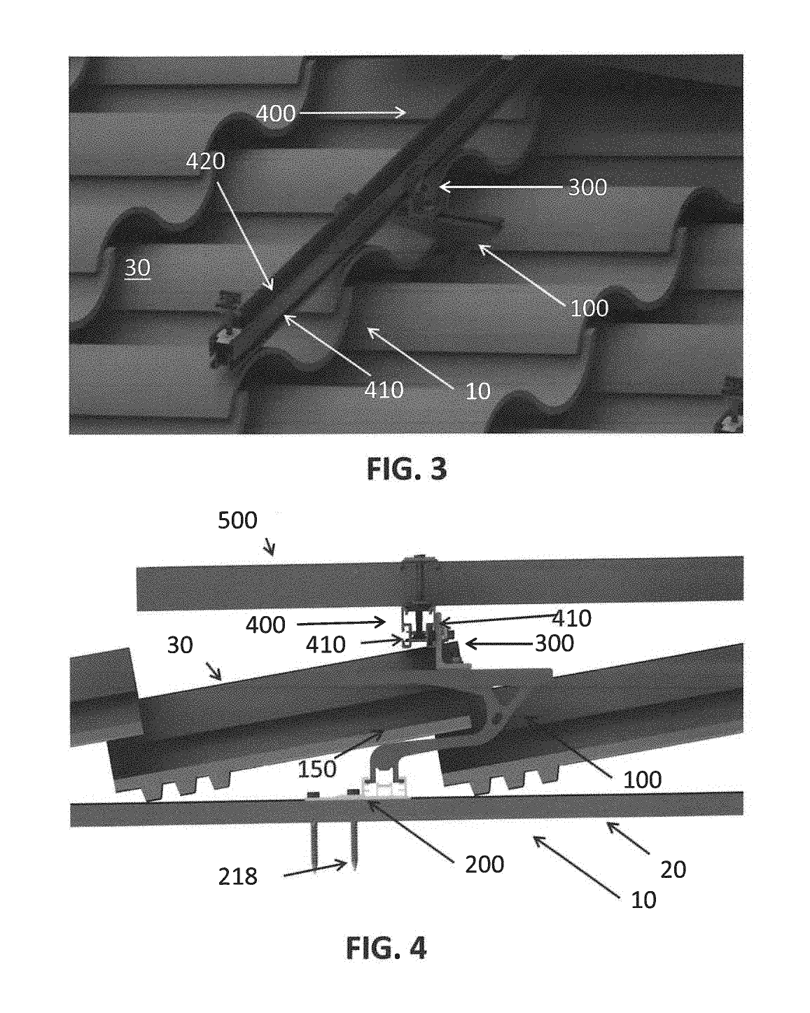

The rail mounting bracket 300, as shown in FIGS. 3-4, is configured to mount on the mounting hook 100 to the rail 400. In an aspect, the rail 400 includes side channels 410 and a top channel 420. In an aspect, the rail mounting bracket 300 comprises a horizontal member 310 and a vertical member 320, which form a substantial right angle. In an aspect, both members 310, 320 include apertures (not shown) configured to receive fastening devices 314, 324 that allow for precise adjustment and placement of the rails 400 in orientation to the mounting hooks 100 through the use of the rail mounting bracket 300 while also securing the rail mounting bracket 300 to the mounting hook 100 and the rail 400 respectively. In an aspect, the fastening devices 314, 324 can include, but are not limited to, a nut and bolt combination.

In an aspect, the fastening devices 314, 324 are configured to be received in the respective channels. For example, the fastening device 314 of the horizontal member 310 of the rail mounting bracket 300 is configured to be received within the channel 134 of the roof mount member 130 of the mounting hook 100. The fastening device 314 can be then slidably moved within the channel 134. Likewise, the fastening device 324 of the vertical member 320 of the bracket 300 is configured to be slidably received by the side channel 410 of the rail 400. In an aspect, flanges 136, 412 keep the respective fastening devices 314, 324 within the channels 134, 410 respectively while allowing the devices 314, 324 to move along their respective channels 134, 410 until the desired positioning has been reached. This allows the mounting bracket 300 to be moved horizontally along the length of the mounting hook 100 and the length of the rail 400 when being mounted. Additionally, the rail 400 can include a top channel similar to the side channels 410 that allow adjustable mounting, including slidably, of the solar components 500 The solar components 500 can be attached through various fasteners configured to fit into the top channel. Such freedom of motion allows for easier adjustment of the solar components 500 and rail 400 along the mounting hook 100 through the mounting bracket 300 when being installed. Without having the adjustability discussed above to move the rail 400, installers would have to be extremely precise and to do so would take a lot of time. By allowing installers more flexibility, the installers can mount the mounting hooks 100 and rails 400 faster, allowing faster installation of the overall system 10, which saves on installation cost.

Having thus described exemplary embodiments of the present invention, it should be noted by those skilled in the art that the disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1. A photovoltaic array rail mounting system for use on surfaces having a support structure and a covering, the system comprising:
a. a mounting hook configured for mounting a rail for solar arrays; and
b. a base plate configured to:
i. be attached to the support structure; and
ii. to receive the mounting hook,
wherein the mounting hook comprises an opening configured to receive the covering.

2. The photovoltaic array rail mounting system of claim 1, wherein the mounting hook comprises a roof mount member configured to couple to the base plate.

3. The photovoltaic array rail mounting system of claim 2, wherein the base plate comprises:
i. a base member; and
ii. an engaging member oriented opposite of the base member comprising a channel configured to receive the roof mount member.

4. The photovoltaic array rail mounting system of claim 3, wherein the roof mount member comprises a bottom portion comprising flanges and a notch, wherein the channel of the engaging member of the base plate is formed from a tab and walls of the engaging member, wherein each wall has a plurality of horizontal flanges along an interior portion, wherein the combination of the horizontal flanges and the tab of the engaging member are configured to receive the flanges and the notch of the bottom portion of the roof mount member and allow for height of the mounting hook to be adjustable within the base plate.

5. The photovoltaic array rail mounting system of claim 1, the mounting hook comprising a rail mount member configured to adjustably receive the rail.

6. The photovoltaic array rail mounting system of claim 5, wherein rail mount member comprises a channel to allow for the rail to be slidably adjusted upon mounting.

7. The photovoltaic array rail mounting system of claim 5, further comprising a rail mounting bracket configured to be adjustably connected to the mounting hook, wherein the rail is further configured to be adjustably connected to the rail mounting bracket.

8. The photovoltaic array rail mounting system of claim 7, wherein the rail comprises a channel to allow for the adjustable connection to the rail mounting bracket.

9. The photovoltaic array rail mounting system of claim 1, wherein the covering comprises roof tiles, wherein the opening of the mounting hook includes is configured to receive the roof tiles.

10. The photovoltaic array rail mounting system of claim 9, further comprising:
c. a rail mounting bracket configured to be adjustably connected to the mounting hook; and
d. a shared rail configured to receive solar components and be adjustably connected to the rail mounting bracket,
wherein the base plate further comprises:
i. a base member; and
ii. an engaging member oriented opposite of the base member, the engaging member comprising a channel formed from a tab and walls of the engaging member, wherein each wall has a plurality of horizontal flanges along an interior portion of the walls; and
wherein the mounting hook further comprises:
i. a roof mount member comprising:
A. a bottom portion comprising:
I. a pair of flanges configured to engage the plurality of horizontal flanges of the channel of the base plate so the height of the mounting hook can be adjusted; and
II. a notch configured to engage the tab of the engaging member of the base plate; and
ii. a rail mount member comprising a channel configured to allow the rail mount member to be mounted and slidably adjustable.

11. A mounting hook configured for mounting a rail for solar arrays on surfaces having a support structure and a covering, the mounting hook comprising:
a. a rail mount member configured to adjustably receive the rail; and
b. an opening configured to receive the covering.

12. The mounting hook of claim 11, wherein the covering comprises tile, and the opening is configured to receive the tile.

13. The mounting hook of claim 11, wherein rail mount member comprises a channel to allow for the rail to be slidably adjusted upon mounting.

14. The mounting hook of claim 13, wherein the channel is configured to receive an adjustable mounting bracket connected to the rail.

15. The mounting hook of claim 11, further comprising a roof mount member configured to adjustably engage a base plate secured to the support structure under the covering.

16. The mounting hook of claim 15, wherein the roof mount member comprises a bottom portion comprising:
i. a pair of flanges; and
ii. a notch,
wherein the pair of flanges are configured to engage a plurality of horizontal flanges of a channel of the base plate so the height of the mounting hook can be adjusted and the notch is configured to engage a tab of the base plate.

17. A method for installing a photovoltaic array rail mounting system on roofs having tiles, the method comprising:
a. removing a single tile;
b. mounting a base plate on a substrate at the location of the removed single tile;
c. attaching a mounting hook to the base plate, wherein the mounting hook comprises an opening to receive the removed single tile;
d. attaching a rail to the mounting hook; and
e. placing the removed single tile back on the roof, wherein a portion of the single tile is received by the opening in the hook.

18. The method of claim 17, wherein attaching the rail to the mounting hook comprises
i. mounting an adjustable mounting bracket to a channel of the mounting hook;
ii. slidably adjusting the position of the mounting bracket within the channel; and
iii. attaching the rail to the mounting bracket.

19. The method of claim 17, wherein attaching the mounting hook to the base plate comprises:
i. engaging a roof mount member of the mounting hook in an engaging portion of the base plate; and
ii. adjusting the height of the mounting hook within the engaging portion.
